(19) United States
(12) Patent Application Publication
(10) Pub. No.: US 2024/0025355 A1
(43) Pub. Date: Jan. 25, 2024

(54) Vehicular Heat Shielding Component, Heat Shielding Film, and Method for Manufacturing Vehicular Heat Shielding Component

(71) Applicants: ART METAL MFG CO., LTD., Ueda-shi Nagano (JP); AKROS CO., LTD., Aichi (JP)

(72) Inventors: Ryoko Yamanoi, Ueda-shi, Nagano (JP); Keisuke Miyamoto, Komaki-shi Aichi (JP); Yosuke Taguchi, Kariyashi Aichi (JP)

(21) Appl. No.: 18/257,094

(22) PCT Filed: Dec. 8, 2021
(86) PCT No.: PCT/JP2021/045191

§ 371 Date: Jun. 12, 2023

(30) Foreign Application Priority Data
Dec. 11, 2020 (JP) 2020206263

(51) Int. Cl. B60R 13/08; C25D 11/08; B05D 7/14; B05D 3/06

(52) U.S. Cl. CPC B60R 13/08; C25D 11/08; B05D 7/146; B05D 3/065; B05D 2601/20; B05D 2202/25

(57) ABSTRACT

Provided is a heat shielding film that is free from release or the like even where the heat shielding film is formed on a top surface of a piston and used in a severe environment such as the inside of an engine combustion chamber, and a vehicular heat shielding component on which the heat shielding film is formed. The vehicular heat shielding component of the present invention is one in which a heat shielding film (1) is formed on at least a part of the surface of a heat shielding target component (2) such as a piston of an engine to be given heat shielding properties. The heat shielding film (1) contains at least an inorganic compound layer (10) having a Vickers hardness (HV) of 50 to 100 in which one or a plurality of types of scale-like inorganic particles (12) selected from a group comprising mica, talc, and wollastonite are dispersed in an inorganic compound (11) formed of an alkoxide. By burning the inorganic compound layer (10) through irradiation of light having a wavelength of 500 nm or less, it is possible to increase the hardness of the inorganic compound layer (10) to 50 to 100 HV described above while suppressing an increase in temperature of the heat shielding target component (2).

### BACKGROUND OF THE INVENTION

### Field of the Invention

The present invention relates to a vehicle heat shield component that is a vehicle component imparted with a heat-shielding property by forming a heat shield film, the heat shield film included in the vehicle heat shield component, and a method of manufacturing the vehicle heat shield component, and relates to a vehicle component (also referred to herein as a “heat shield target component”) requiring impartation of the heat-shielding property such as a vehicle heat shield component including heat shield films formed on top surfaces of pistons of an engine, the heat shield film, and a method of manufacturing the vehicle heat shield component.

### Description of Related Art

Heat shield films have been formed on top surfaces of pistons to improve fuel efficiency and the like, in particular, to reduce heat loss caused when heat generated in a combustion chamber of an engine is discharged through the pistons. This results in improvement in heat efficiency.

As an example of the heat shield films, Patent Document 1 listed below describes a heat-insulation film to be formed on a top surface of a piston. The heat-insulation film includes a heat-insulative layer and an inorganic-system coated-film layer. The heat-insulative layer includes resin in which hollow particles are buried. The inorganic-system coated-film layer includes hollow particles formed on a surface of the heat-insulative layer and includes inorganic material such as silica, zirconia, alumina, and ceria.

However, when using the heat-insulation film according to Patent Document 1, the resin heat-insulative layer and the inorganic-system coated-film layer including hollow particles do not achieve sufficient heat resistance in a high-temperature environment such as in the combustion chamber of the engine, and cracks may occur in the inorganic-system coated-film layer such that the inorganic-system coated-film layer tends to be peeled off. Therefore, Patent Document 2 listed below have proposed using an alumite layer as the heat-insulative layer to be formed on the top surface of the piston, forming an inorganic compound layer on the heat-insulative layer (alumite layer), and forming a heat shield film including the alumite layer and the inorganic compound layer having scale-like inorganic particles dispersed in an inorganic compound that includes alkoxide (see FIG. 10 and FIG. 11 in Patent Document 2).

### RELATED ART DOCUMENTS

### Patent Document

Patent Document 1 Japanese Patent No. 6067712 Patent Document 2 Japanese Patent No. 6339118

### BRIEF SUMMARY OF THE INVENTION

### Problems to be Solved by the Invention

The heat shield film according to Patent Document 2 listed above overcomes a problem of Patent Document 1 that the heat-insulation film according to Patent Document 1 has low heat resistance, by replacing the heat-insulative layer including resin and hollow particles according to Patent Document 1 with the alumite layer, and by replacing the inorganic-system coated-film layer including hollow particles and inorganic material according to Patent Document 1 with the inorganic compound layer having scale-like inorganic particles dispersed in the inorganic compound that includes alkoxide.

However, when the heat shield films according to Patent Document 2 listed above was formed on pistons and an engine including the pistons was driven (“actual engine test”), peeling off of portions of the heat shield films was observed, and it was recognized that the heat shield films did not have enough mechanical strength to be formed on the top surfaces of the pistons of the engine.

In particular, in unit testing performed in an environment where only the inorganic compound layer having scale-like inorganic particles dispersed therein is formed and the engine is simulated, it is observed that, when the inorganic compound layer has a thickness of 40 μm or more, the inorganic compound layer peels off prominently. Therefore, it is impossible to employ a configuration omitting the heat-insulative layer provided below the inorganic compound layer by increasing the thickness of the inorganic compound layer so as to allow the inorganic compound layer to function as the single inorganic compound layer.

Here, one of the ways to increase the hardness of the inorganic compound that is formed by using the alkoxide as starting material is to increase the temperature for baking the inorganic compound layer.

However, when the inorganic compound layer is baked at a high baking temperature to form the heat shield film on the heat shield target component such as an aluminum alloy piston, the external dimension of the heat shield target component temporarily changes due to thermal expansion caused by heat produced during the baking, and also permanently changes due to released residual stress or the like. Therefore, sometimes the sizes of the pistons may deviate from a designed value and clearance between the pistons and cylinder bores may change if the heat shield target components are the pistons, for example.

Accordingly, the baking is desirably performed at a lowest possible temperature, and it is inappropriate to employ the way of increasing the hardness of the protective layer by increasing the baking temperature.

In addition, in an embodiment of Patent Document 2, oxalic acid alumite is formed as the alumite layer serving as the heat-insulative layer through an anodizing process using an oxalic acid bath. However, the oxalic acid alumite has a high porosity and is fragile. Therefore, it is recognized that defect of a coated film occurs in an actual single cylinder test where only the alumite layer is formed. As a result, the alumite layer formed below the inorganic compound layer also peels off when the inorganic compound layer peels off, and this destroys the effect of improving fuel efficiency and the like by the heat shield film.

Therefore, the present invention has been made to solve the above-described drawbacks in the related arts, and an object of the present invention is to provide a heat shield film and a method of forming the heat shield film that does not peel off even in a tough environment such as in a combustion chamber of an engine.

### Means for Solving the Problem

Means for solving the problems are described below with reference numerals used in the detailed description of the preferred embodiments. These reference numerals are intended to clarify the correspondence between the descriptions in the claims and the descriptions in the detailed description of the preferred embodiments, and it is needless to say that these reference numerals should not be used to restrictively interpret the technical scope of the present invention.

In order to achieve the object of the present invention, a vehicle heat shield component according to the present invention comprises:
a heat shield film 1 that covers at least a portion of a surface of a heat shield target component 2,
the heat shield film 1 including at least an inorganic compound layer 10 having one or more kinds of scale-like inorganic particles 12 dispersed in an inorganic compound 11 that includes alkoxide, the one or more kinds of scale-like inorganic particles 12 being selected from a group consisting of mica, talk, and wollastonite, and
the inorganic compound layer 10 having a Vickers hardness of 50 to 100 HV.

The inorganic compound layer 10 may have a Young's modulus of 12 to 25 GPa.

The heat shield film 1 may further include an alumite layer 20 below the inorganic compound layer 10.

In such case, it is preferable that the alumite layer 20 is a sulfuric-acid alumite layer.

The inorganic compound layer 10 may have a thickness of 10 to 200 μm.

Moreover, the heat shield film 1 may have a thickness of 10 to 400 μm.

Note that, the vehicle heat shield component according to the present invention is different from known vehicle heat shield components having high hardness by baking an inorganic compound layer in an atmosphere furnace with high temperature, in that the vehicle heat shield component according to the present invention has a relatively high hardness of 50 to 100 HV while the heat shield target component 2 has an external dimension having been maintained since before the heat shield film 1 is formed, without permanent thermal deformation of the heat shield target component 2.

The alkoxide may be a mixture of 30 to 100 mass % of tetrafunctional alkoxide and 0 to 70 mass % of bifunctional or trifunctional alkoxide.

The heat shield target component 2 may be a piston for an engine.

A heat shield film 1 according to the present invention formed on a portion of at least a surface of a heat shield target component 2, constituting a vehicle heat shield component with the heat shield target component 2, the heat shield film 1 comprises:
at least an inorganic compound layer 10 having one or more kinds of scale-like inorganic particles 12 dispersed in an inorganic compound 11 that includes alkoxide, the one or more kinds of scale-like inorganic particles 12 being selected from a group consisting of mica, talk, and wollastonite, the inorganic compound layer 10 having a Vickers hardness of 50 to 100 HV.

An alumite layer 20 may be provided below the inorganic compound layer 10.

In such case, the alumite layer 20 may have a thickness of 10 to 200 μm.

Moreover, the inorganic compound layer 10 may have a thickness of 10 to 200 μm.

The heat shield film 1 according to the present invention is formed on a surface of the heat shield target component 2 having an external dimension that has been maintained since before the heat shield film 1 is formed.

Furthermore, a method of manufacturing a vehicle heat shield component according to the present invention including a heat shield film 1 that covers at least a portion of a surface of a heat shield target component 2, the heat shield film 1 including at least an inorganic compound layer 10 having one or more kinds of scale-like inorganic particles 12 dispersed therein, the one or more kinds of scale-like inorganic particles 12 being selected from a group consisting of mica, talk, and wollastonite, comprises:
a paint manufacturing step of manufacturing paint including an alkoxide solution including scale-like inorganic particles 12 dispersed therein;
a coating film forming step of forming a coating film by applying the paint to the surface of the heat shield target component 2; and
a baking step of baking the coating film by irradiation of a light having a wavelength of 500 nm or less, preferably, a wavelength in ultraviolet band (200 to 400 nm).

In the method of manufacturing a vehicle heat shield component, the alkoxide may be a mixture of 30 to 100 mass % of tetrafunctional alkoxide and 0 to 70 mass % of bifunctional and/or trifunctional alkoxide.

Furthermore, the heat shield film 1 may include an alumite layer 20, and the coating film forming step may be performed on the surface of the heat shield target component 2 that includes aluminum or an aluminum alloy and on which the alumite layer 20 is formed.

In such case, it is preferable that the alumite layer 20 is formed through an anodizing process using a sulfuric acid bath.

Furthermore, the heat shield target component 2 may be a piston for an engine.

### Effect of the Invention

The configuration of the present invention that has been described above has allowed to obtain the following remarkable effects from the vehicle heat shield component and the heat shield film 1 of the present invention.

Since the inorganic compound layer 10 has a relatively high Vickers hardness of 50 to 100 HV, it is possible to obtain the inorganic compound layer 10 that does not tend to peel off even if its film thickness increases. In addition, since the inorganic compound layer 10 has the increased film thickness and has an improved heat-shielding property, it is possible for the single inorganic compound layer 10 to function as the heat shield film without forming any heat-insulative layer such as the alumite layer 20 below the inorganic compound layer 10.

However, this does not exclude to employ a configuration providing the alumite layer 20 below the inorganic compound layer 10 or providing another heat-insulative layer (not illustrated) in addition to or instead of the alumite layer 20 below the inorganic compound layer 10.

In addition, it is possible to impart flexibility to the inorganic compound layer 10 since the inorganic compound layer 10 has a Young's modulus of 12 to 25 GPa.

As described above, since the inorganic compound layer 10 are imparted with flexibility, the inorganic compound layer 10 does not tend to crack. Therefore, it is possible to provide the heat shield film 1 that is much more difficult to peel off.

When the heat shield film 1 further includes the alumite layer 20 below the inorganic compound layer 10, the heat shield film 1 can achieve a more improved heat-shielding effect by a heat-insulating effect of the alumite layer 20.

In particular, in a case where the alumite layer 20 is a sulfuric-acid alumite layer formed through an anodizing process using a sulfuric acid bath, the alumite layer 20 has a higher density and a higher hardness than an alumite layer formed using oxalic acid. Note that, the vehicle heat shield component according to the present invention has

the relatively high hardness of 50 to 100 HV while the heat shield target component 2 has an external dimension having been maintained since before the heat shield film 1 is formed, without permanent thermal deformation of the heat shield target component 2. Therefore, it is possible to substantially maintain clearance between pistons and cylinder bores as designed, even in a case where the heat shield target component 2 is the piston of the engine, for example.

In addition, in the method of manufacturing the vehicle heat shield component according to the present invention, light having a wavelength of 500 nm or less, more preferably light having a wavelength in ultraviolet band (200 to 400 nm) is radiated to bake a coating film through a baking process. This makes it possible to maintain the temperature of the heat shield target component 2 at a relatively low temperature and the inorganic compound 11 of the inorganic compound layer 10 has a high hardness.

Accordingly, it is possible to form the inorganic compound layer 10 having the high hardness on the heat shield target component 2 while maintaining dimensional accuracy of the heat shield target component 2 even in a case where the heat shield target component 2 is a component such as an aluminum alloy piston to be used in the engine, whose dimension tend to vary due to thermal expansion caused when heated to a high temperature.

In addition, as described above, the temperature of the heat shield target component 2 can be maintained at a low temperature. This makes it possible to form the inorganic compound layer 10 having a high hardness without losing microcrystal structure, residual stress, and the like of the heat shield target component 2 due to heat during the baking, even in a case where the heat shield film 1 is formed on the heat shield target component 2 imparted with the microcrystal structure, residual stress, and the like through forging, thermal process, and the like.

### BRIEF DESCRIPTION OF THE SEVERAL VIEWS OF THE DRAWINGS

FIG. 1 is an explanatory diagram illustrating a vehicle heat shield component including a heat shield film (single-layer structure) according to the present invention.

FIG. 2 is an explanatory diagram illustrating a vehicle heat shield component including a heat shield film (double-layer structure) according to the present invention.

FIG. 3 is an explanatory diagram illustrating a process of forming an inorganic compound layer.

FIG. 4 is a graph illustrating change in rate of hydrolysis reaction with respect to pH change in alkoxide (Si alkoxide).

FIG. 5 is a graph illustrating change in optical transmittance of alkoxide paint with respect to change in wavelength of radiation light.

FIG. 6 is a graph illustrating change in reflectance of alkoxide paint with respect to change in wavelength of radiation light.

FIG. 7 is a graph illustrating change in optical absorptance of alkoxide paint with respect to change in wavelength of radiation light.

FIG. 8 illustrates an FT-IR spectrum of an inorganic compound (obtained through baking by irradiation of ultraviolet light for predetermined duration) according to a first embodiment.

FIG. 9 illustrates an FT-IR spectrum of an inorganic compound (obtained through baking by irradiation of ultraviolet light for predetermined duration (short duration) that is shorter than the predetermined duration according to the first embodiment) according to a second embodiment.

FIG. 10 illustrates FT-IR spectra of an inorganic compound (obtained through baking in an atmosphere furnace with low temperature) according to a first comparative example and an inorganic compound (obtained through baking in an atmosphere furnace with high temperature) according to a second comparative example.

FIG. 11 illustrates FT-IR spectra of the inorganic compound (obtained through baking by irradiation of ultraviolet light for short duration) according to the second embodiment and the inorganic compound (obtained through baking in the atmosphere furnace with low temperature) according to the first comparative example.

FIG. 12 is a graph illustrating comparison between hardness (HV) of the inorganic compound (obtained through baking by irradiation of ultraviolet light for short duration) according to the second embodiment and hardness (HV) of the inorganic compound (obtained through baking in the atmosphere furnace with low temperature) according to the first comparative example.

FIG. 13 is a graph illustrating a differential thermal analysis (TG-DTA) of a sample before pH adjustment.

FIG. 14 is a graph illustrating a differential thermal analysis (TG-DTA) of a sample after pH adjustment.

FIG. 15 is a graph illustrating change in hardness of an inorganic compound before/after pH adjustment, the inorganic compound being obtained through baking in an atmosphere furnace.

FIG. 16 is a graph illustrating change in hardness of an inorganic compound before/after pH adjustment, the inorganic compound being obtained through baking by irradiation of ultraviolet light.

FIG. 17 is a graph illustrating change in hardness of an inorganic compound depending on amine supplementation (pH adjustment).

FIG. 18 is a graph illustrating change in Young's modulus of an inorganic compound with respect to change in trifunctional alkoxide content.

FIG. 19 is a graph illustrating change in hardness (HV) of respective inorganic compounds depending on amine supplementation (pH adjustment), the inorganic compounds including an inorganic compound having 0 mass % of trifunctional alkoxide, an inorganic compound having 17 mass % of trifunctional alkoxide, an inorganic compound having 33 mass % of trifunctional alkoxide, and an inorganic compound having 50 mass % of trifunctional alkoxide.

FIG. 20 is an explanatory diagram illustrating test equipment used in hydropulse test.

### DETAILED DESCRIPTION OF THE INVENTION

Hereinafter, embodiments of the present invention will be described with reference to the attached drawings.

Overall Configurations of Vehicle Heat Shield Component and Heat Shield Film

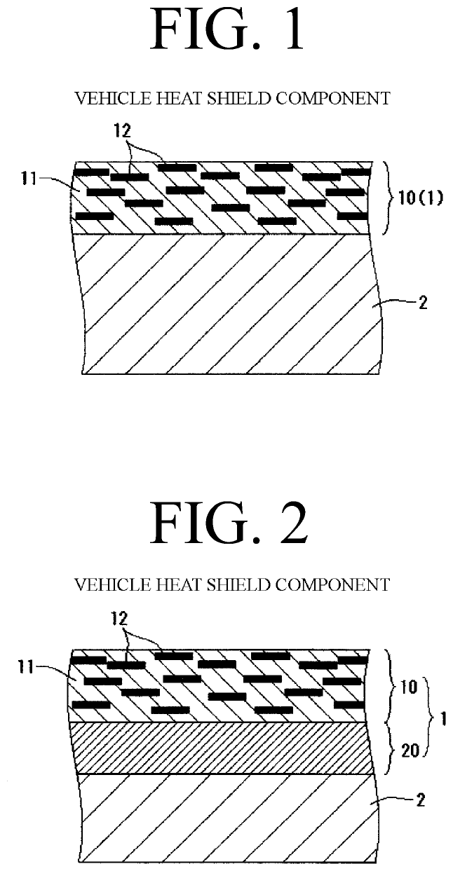

As illustrated in FIG. 1 and FIG. 2, a vehicle heat shield component according to the present invention includes a heat shield target component 2 and a heat shield film 1, and is imparted with a heat-shielding property. The heat shield target component 2 is a metal component for a vehicle such as a piston of an engine. The heat shield film 1 is formed on at least a portion of a surface of the heat shield target component 2, for example, on a top surface of the piston.

As illustrated in FIG. 1 and FIG. 2, the heat shield film 1 is a film formed on the surface of the heat shield target component 2 to block heat conduction to the heat shield target component 2. The heat shield film 1 includes at least an inorganic compound layer 10 having scale-like inorganic particles 12 dispersed in an inorganic compound 11 that includes alkoxide.

FIG. 1 illustrates a heat shield film 1 including a single layer that is the above-described inorganic compound layer 10. FIG. 2 illustrates a heat shield film 1 including double layers that are the inorganic compound layer 10 and an alumite layer 20 formed below the inorganic compound layer 10.

For example, the heat shield film has a thickness of 10 to 200 μm in the case where the heat shield film 1 includes the single layer that is the inorganic compound layer 10 as illustrated in FIG. 1.

Alternatively, in the case where the heat shield film 1 includes the double layers that are the inorganic compound layer 10 and the alumite layer 20 as illustrated in FIG. 2, the heat shield target component 2 includes aluminum or an aluminum alloy, the alumite layer 20 is formed through an anodizing process performed in advance on the heat shield target component 2, and the above-described inorganic compound layer 10 is formed on the alumite layer 20.

As described above, in the case where the heat shield film 1 is a double-layer film including the inorganic compound layer 10 and the alumite layer 20, for example, the heat shield film 1 has a total thickness of 20 to 400 μm. In the total thickness, the inorganic compound layer has a thickness of 10 to 200 μm and the alumite layer has a thickness of 10 to 200 μm.

Note that, the heat shield film 1 according to the present invention is not limited to the configurations illustrated in FIG. 1 and FIG. 2. Instead of the alumite layer 20, the heat shield film 1 may include a known heat-insulative layer such as a heat-insulative layer including inorganic material in which hollow particles are dispersed, for example. Alternatively, the heat shield film 1 may include a known heat-insulative layer such as the heat-insulative layer including inorganic material in which hollow particles are dispersed, between the alumite layer 20 and the inorganic compound layer 10 illustrated in FIG. 2. Various kinds of configuration can be employed as long as the heat shield film 1 includes at least the inorganic compound layer 10.

Inorganic Compound Layer

Among the layers included in the heat shield film 1 according to the present invention, the above-described inorganic compound layer 10 has scale-like inorganic particles 12 dispersed in the inorganic compound 11 that includes alkoxide as described above. In addition, the inorganic compound layer 10 has a relatively high Vickers hardness of 50 to 100 HV. As illustrated in FIG. 1 and FIG. 2, longitudinal sides of the scale-like inorganic particles 12 are parallel to a surface of the heat shield target component, and the scale-like inorganic particles 12 are bonded while the inorganic compound 11 including alkoxide serves as a binder.

Examples of the scale-like inorganic particles 12 dispersed in the inorganic compound layer 10 include mica, talk, and wollastonite. These may be used alone, or may be used in combination.

Here, the scale-like shape means a shape having thickness that is sufficiently smaller than its length. The scale-like shape includes a plate-like shape, a flake-like shape, a fiber-like shape, and a needle-like shape as long as its thickness is sufficiently smaller than its length.

The scale-like inorganic particles 12 dispersed in the inorganic compound layer 10 has a preferable size of about 1 to 500 μm in average length, more preferably about 1 to 50

The scale-like inorganic particles 12 dispersed in the inorganic compound layer 10 are 20 to 70% in mass ratio.

The inorganic compound 11 that is the other material included in the inorganic compound layer 10 is a metal oxide formed through a sol-gel process using the alkoxide as starting material.

The alkoxide serving as the starting material is a compound obtained when hydrogen (H) of a hydroxyl group (—OH) of an alcohol is substituted by metal. The sol-gel process is a process of using the alkoxide as the starting material and synthesizing the metal oxide as a final product via a sol state and a gel state through hydrolysis reaction and polycondensation reaction.

Various kinds of metal can be used as the metal of alkoxide as long as the metal oxide can be formed through the sol-gel process. For example, it is possible to use silicon (Si), zirconium (Zr), titanium (Ti), aluminium (Al), cerium (Ce), boron (B), or the like as the metal of alkoxide. Among them, it is preferable to use silicon (Si) and zirconium (Zr) because these have high hardness and these can be acquired inexpensively comparatively.

Such an alkoxide may be used alone, or a plurality of types of alkoxides may be used in combination.

To obtain the inorganic compound layer 10 having a high hardness, it is preferable to use tetrafunctional alkoxides as the starting material such as tetramethoxysilane, tetraethoxysilane, and tetrapropoxysilane. It is also possible to use a tetrafunctional alkoxide alone.

Note that, in the case where a tetrafunctional alkoxide is used alone, an inorganic compound layer 10 having a high hardness and a high Young's modulus is obtained. However, the high Young's modulus makes it difficult to deform the inorganic compound layer 10. Therefore, the inorganic compound layer 10 tends to crack while in use depending on its use, material of the heat shield target component 2, or the like.

Accordingly, to impart flexibility, a high hardness, a low Young's modulus to the inorganic compound layer 10, it is preferable to use alkoxides obtained by adding bifunctional and/or trifunctional alkoxides to the tetrafunctional alkoxide serving as base material.

It is possible to use various kinds of alkoxides that includes R¹M(OR²)₃ representing a trifunctional alkoxide, and R¹₂M(OR²)₂ representing a bifunctional alkoxide, where “M” represents metal such as Si, Ti, Zr, Al, or B, “R¹” represents an monovalent organic group, in particular such as an alkyl group, an alkenyl group, an alkynyl group, or an aryl group, and “R²” represents a C1-C4 alkyl group, in particular such as a methoxy group, an ethoxy group, or a propoxy group.

Examples of the trifunctional alkoxide include methyltriisopropoxysilane, methyltrimethoxysilane, ethyltrimethoxysilane, propyltrimethoxysilane, isopropyltrimethoxysilane, methyltriethoxysilane, ethyltriethoxysilane, propyltriethoxysilane, isopropyltriethoxysilane, butyltriethoxysilane, isobutyltriethoxysilane, ethyltripropoxysilane, methyltriisopropoxysilane, ethyltriisopropoxysilane, and the like.

Examples of the bifunctional alkoxide include dimethyldimethoxysilane, dimethyldiethoxysilane, dimethyldipropoxysilane, diethyldimethylsilane, diethyldiethoxysilane, diethylldipropoxysilane, dipropyldimethoxysilane, dipropyldiethoxysilane, and dipropyldipropoxysilane.

For example, as the alkoxides obtained by mixing alkoxides with different number of functional groups, it is possible to use a mixture of 30 to 90 mass % of tetrafunctional alkoxide and 10 to 70 mass % of bifunctional and/or trifunctional alkoxide.

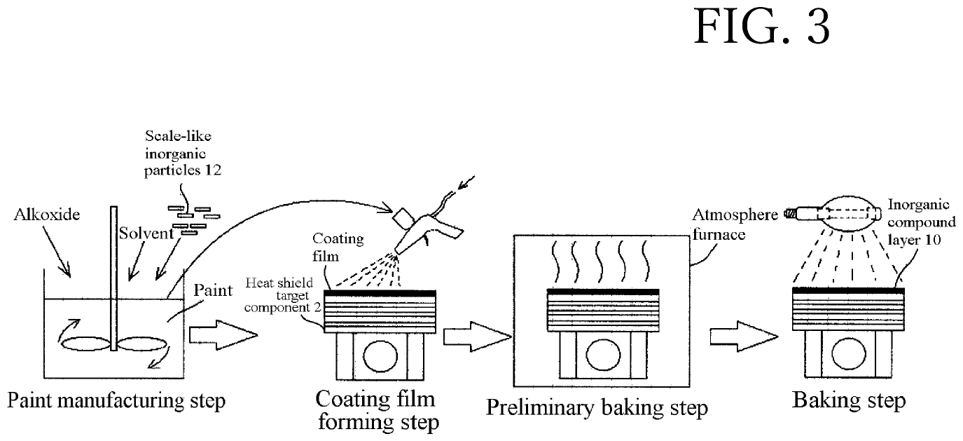

FIG. 3 illustrates an example of using the alkoxides as the starting material and forming the inorganic compound layer 10 through the sol-gel process.

To form the inorganic compound layer 10 through the sol-gel process, a raw material solution is first prepared by mixing the alkoxides and a solvent, and paint (hereinafter, also referred to as “alkoxide paint”) is manufactured by dispersing the scale-like inorganic particles 12 in the raw material solution (paint manufacturing step).

Since alkoxy groups are hydrophobic, lower alcohol that is hydrophobic and hydrophilic such as methanol, ethanol, n-propyl alcohol, isopropyl alcohol, n-butanol, or isobutyl alcohol may be used as the solvent.

In the example illustrated in FIG. 3, the scale-like inorganic particles 12 are added simultaneously with mixing of the alkoxides and the solvent. Instead, it is also possible to obtain a raw material solution (sol) by mixing the alkoxides and the solvent, add the scale-like inorganic particles 12 into the raw material solution, and stir/disperse the mixture to manufacture the alkoxide paint. Alternatively, it is also possible to add and mix the scale-like inorganic particles 12 into the alkoxides or the solvent in advance, and then mix the alkoxides and the solvent.

Next, a coating film is formed by applying the paint manufactured in the above-described step to the surface of the heat shield target component 2 through a known method such as spin coating, dip coating, or spray coating (coating film forming step).

If necessary, the coating film formed on the surface of the heat shield target component 2 is baked preliminarily in the atmosphere furnace or the like (preliminary baking step).

Subsequently, the coating film is baked by irradiation of light (electromagnetic wave) (baking step), and then the inorganic compound layer 10 having the scale-like inorganic particles dispersed in the inorganic compound that includes metallic oxide.

As a result of an experiment to be described later, it is confirmed that light that is most absorbable by the coating film is light having a wavelength of 500 nm or less, more preferably light having a wavelength in ultraviolet band (200 to 400 nm). Therefore, the above-described baking step is performed while using a metal halide lamp as a light source for radiating ultraviolet light.

When the metal halide lamp is used as the light source, its light radiation condition may include a condition that the light source has an amount of heat of 2 to 4 kW and a peak illuminance of 700 to 1800 mW/cm², for example.

It is preferable to add a pH adjuster into the paint in such a manner that the paint has a higher pH than before pH adjustment, desirably a pH of 9.5 or more, or in such a manner that the paint has a pH of 4 or less. In the case of adjusting the pH of the paint to 4 or less (acidic property), it is possible to use a mineral acid (hydrochloric acid or phosphoric acid), an organic acid (acetic acid, citric acid, or oxalic acid), or a carboxylic anhydride (phthalic anhydride or maleic anhydride) as the pH adjuster. Alternatively, in the case of adjusting the pH of the paint to a higher pH than before pH adjustment, it is possible to use an amine (m-xylylenediamine or triethylamine) and ammonia as the pH adjuster.

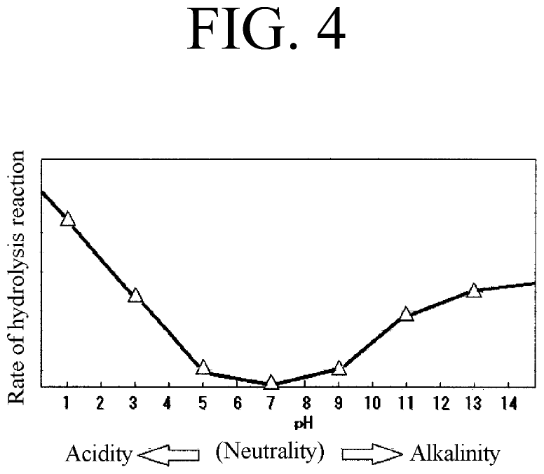

FIG. 4 illustrates change in rate of hydrolysis reaction with respect to pH change in the raw material solution (sol) obtained by mixing the alkoxides and the solvent.

As illustrated in FIG. 4, it is possible to drastically improve the rate of hydrolysis reaction of the paint by adding the pH adjuster and adjusting the pH of the paint (raw material solution) toward an acidic direction or toward an alkaline direction. This makes it possible to improve reactivity during the preliminary baking step and the baking step, to shorten the time it takes to perform the preliminary baking step and the baking step, and to increase the hardness of the inorganic compound layer 10 to be obtained.

Alumite Layer

As illustrated in FIG. 1, the heat shield film 1 according to the present invention may include the single layer that is the inorganic compound layer 10. However, as illustrated in FIG. 2, it is also possible to form a heat shield film 1 including the double layers that are the inorganic compound layer 10 and the alumite layer 20 formed below the inorganic compound layer 10 in the case where the heat shield target component 2 includes aluminum or an aluminum alloy.

Before forming the inorganic compound layer 10, the alumite layer 20 is formed in advance through the anodizing process performed on the heat shield target component 2 including aluminum or an aluminum alloy.

Such an alumite layer 20 may be an oxalic-acid alumite layer formed through an anodizing process using an oxalic acid bath, or may be a sulfuric-acid alumite layer formed through an anodizing process using a sulfuric acid bath.

Note that, the hardness (70 to 90 HV) of the alumite layer 10 formed using the oxalic acid bath is lower than the hardness (150 HV or more) of the alumite layer 10 formed using the sulfuric acid bath. Therefore, it is preferable to employ the alumite layer 10 formed using the sulfuric acid bath.

Heat Shield Target Component

The above-described heat shield film 1 according to the present invention is formed on the heat shield target component 2 that is a metal component for a vehicle such as a piston of an engine as described above.

When using the above-described method of forming the heat shield film, it is possible to form the heat shield film 1 (inorganic compound layer 10) having a high hardness on the surface of the heat shield target component 2 while suppressing increase in the temperature of the heat shield target component 2. This makes it possible to prevent permanent change or the like in the external dimension of the heat shield target component 2 due to the residual stress released when the heat shield target component 2 is heated to a high temperature during baking. Even in a case where the heat shield film 1 is formed on an aluminum or an aluminum alloy product whose dimension may vary relatively drastically through heating, on a product with a microcrystal structure through forging or thermal process, or on other products, it is possible to obtain the inorganic compound layer 10 having the relatively high hardness of 50 to 100 HV while maintaining its dimensional accuracy obtained before forming the heat shield film 1. Furthermore, this makes it possible to suppress change in internal structure of the heat shield target component 2 due to crystal grain growth. Therefore, for example, the above-described method is suitable to form the heat shield film on the heat shield target component 2 such as the aluminum alloy piston to be used in the engine, for example.

### Embodiments

Next, the following will describe results of respective tests performed to find an optimum condition on formation of the heat shield film according to the present invention, and results of a fatigue test and endurance test of the heat shield films formed through the method according to the present invention.

Confirmation of Optimum Wavelength of Radiation Light used in Baking Step]

(1) Object and Point of View of Experiment

An object of this experiment is to find a wavelength range of light that is highly absorbable by the coating film of the alkoxide paint.

When using a conventional method of baking a coating film in an atmosphere furnace, the heat shield target component 2 on which the coating film is formed is put into the atmosphere furnace and baked. Therefore, as the temperature of the baking (temperature in furnace) increases, not only the temperature of the coating film but also the temperature of the heat shield target component 2 increase, and this may result in permanent change in the dimension of the heat shield target component 2. Therefore, it is impossible to increase the temperature of the baking, and the inorganic compound layer 10 having a low hardness is obtained.

To solve the above-described drawback and obtain the inorganic compound layer 10 having the relatively high hardness of 50 to 100 HV while maintaining the dimensional accuracy of the heat shield target component 2 before/after forming the inorganic compound layer 10, it is necessary to use a new baking method that makes it possible to suppress increase in temperature of the heat shield target component 2 and heat only the coating film.

With regard to such a baking method, the inventors of the present invention conducted the following experiment of finding light having wavelength that is highly absorbable by the coating film of the alkoxide paint as a first step to explore the possibility of achieving such a baking method, on an assumption that it may be possible to suppress increase in temperature of the heat shield target component 2 and heat only the coating film by irradiating the coating film with the light having wavelength that is highly absorbable by the coating film.

(3) Method of Experiment

Samples were prepared by applying the alkoxide paint having thicknesses of 11 μm, 21 μm, and 60 μm to borosilicate glass substrates. The alkoxide paint includes mica as the scale-like inorganic particles. Next, the respective samples were irradiated with light having wavelengths of 260 to 2200 nm to measure change in optical transmittance, reflectance, and absorptance depending on change in wavelength.

(3) Result of Experiment

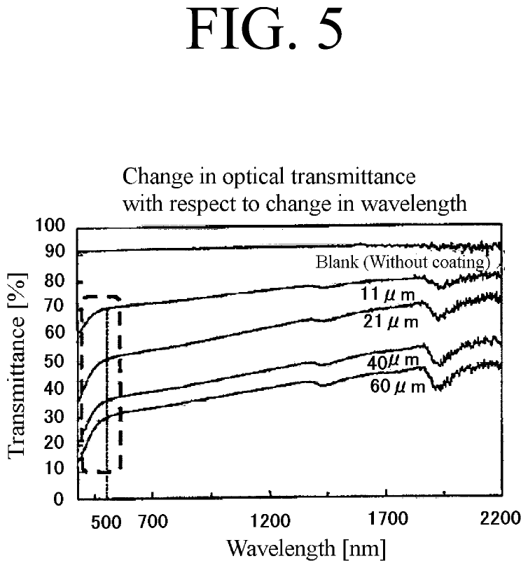

Among the above-described tests, FIG. 5 illustrates the change in optical

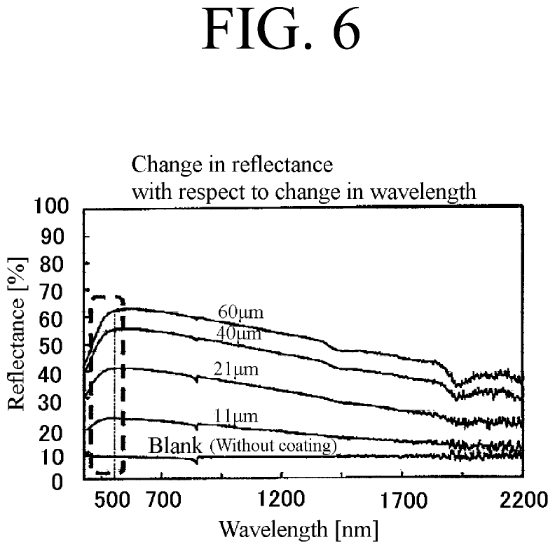

transmittance, and FIG. 6 illustrates change in reflectance of the respective samples with regard to the irradiation of the light having wavelengths of 260 to 2200 nm.

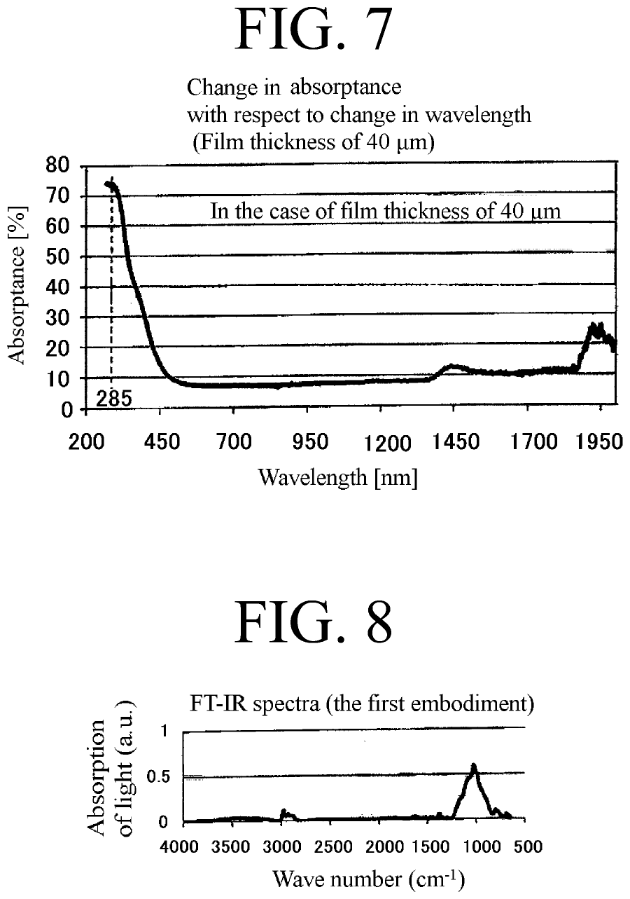

Among them, FIG. 7 illustrates absorptance of the sample on which the coating film having the thickness of 40 μm is formed.

(4) Consideration

As illustrated in FIG. 5 and FIG. 6, the optical transmittance and reflectance of every samples on which the coating films having various film thicknesses are formed drastically deteriorate when irradiated with the light having wavelength of 500 nm or less. It was observed that both the optical transmittance and reflectance deteriorate as the wavelength gets shorter.

Note that, the light absorbed by the coating film is obtained by eliminating the transmitted light and the reflected light from the entire radiation light. Therefore, the above-described results show that the optical absorptance of all the samples increase as the wavelength gets shorter in a wavelength range of 500 nm or less. Accordingly, it is recognized that radiation of light having wavelength of 500 nm or less is effective to heat only the coating film while suppressing increase in the heat shield target component 2.

Note that, with reference to FIG. 7 illustrating the absorptance of the sample on which the coating film having the film thickness of 40 μm is formed, the absorptance reaches its peak that is slightly above 70% when the light has an wavelength of 285 nm. Similar results were also obtained in cases of the other samples than the sample having the film thickness of 40 μm.

Therefore, it is confirmed that, when radiating light having a wavelength in the ultraviolet band (200 to 400 nm), more preferably light having the wavelength of 285 nm or less, it is possible to increase the temperature of the coating film to its maximum while suppressing increase in the temperature of the heat shield target component.

Note that, when radiating light having a wavelength of 500 nm or more, it is considered that the optical transmittance and reflectance become high, the light is not absorbed by the coating film, and a poor heating effect is obtained.

Confirmation of Effect of Baking by Irradiation of Ultraviolet Light

(1) Object of Test Through the above-described test of confirming the optimum wavelength, it is confirmed whether the reaction is accelerated (no hydroxyl group remains) and whether the hardness is increased with regard to the inorganic compound obtained by irradiation of the light having the wavelength of 500 nm or less that is highly absorbable by the coating film.

(3) Method of Test

An inorganic compound (silicic acid compound) is prepared in a first embodiment, and another inorganic compound is prepared in a second embodiment. The inorganic compound according to the first embodiment is obtained when a raw material solution that is a mixture of a solvent and a tetrafunctional silicon alkoxide (no pH adjuster or no scale-like inorganic particles is added) is irradiated with ultraviolet light for a predetermined duration by using a metal halide light source (having a wavelength of 200 to 400 nm and an output of 80 W/cm) at an irradiation distance of 440 nm to perform baking. The inorganic compound according to the second embodiment is obtained when a raw material solution that is similar to the raw material solution according to the first embodiment is irradiated with ultraviolet light for a shorter duration (short duration) than the first embodiment by using a similar metal halide light source at an irradiation distance of 245 nm to perform baking.

In a first comparative example, an inorganic compound is prepared by baking a similar raw material solution in an atmosphere furnace with low temperature (that does not cause permanent change in dimension of a heat shield target component). In a second comparative example, an inorganic compound is prepared by baking a similar raw material solution in an atmosphere furnace with high temperature (that causes permanent change in dimension of a heat shield target component).

Reaction progress states of the respective inorganic compounds according to the first embodiment, the second embodiment, the first comparative example, and the second comparative example were checked through Fourier-transform infrared spectroscopy (FTIR).

With regard to the reaction progress states, an inorganic compound in which Si—O stretching vibration is observed but no Si—OH stretching vibration is observed from its spectrum shape is evaluated as a “state where reaction is completed”, and the other inorganic compound are evaluated as a “state where reaction is incomplete”.

In addition, hardness (HV) of the respective samples is also measured after baking.

(3) Result of Test

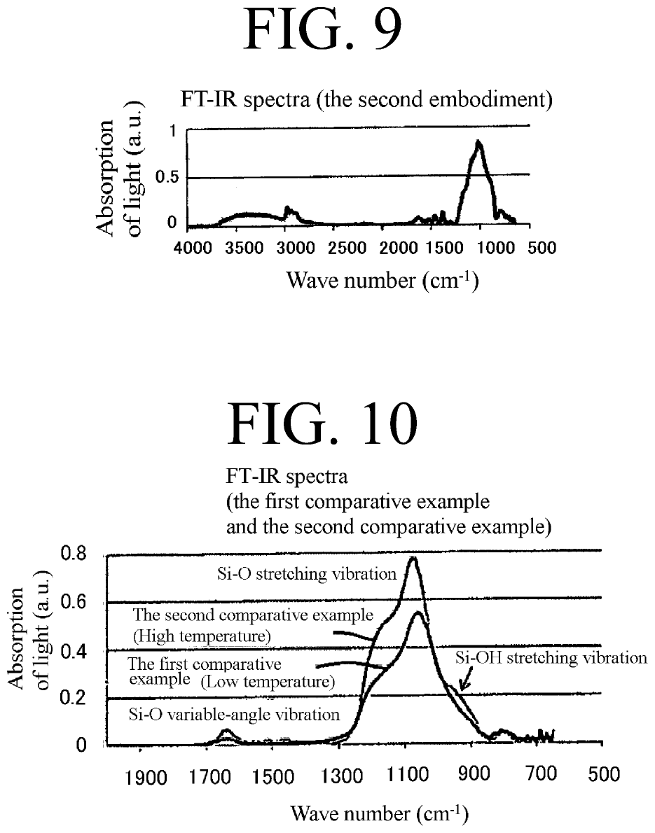

FIG. 8 and FIG. 9 respectively illustrate FT-IR spectra of the inorganic compound according to the first embodiment and the inorganic compound according to the second embodiment after baking is performed by radiating ultraviolet light.

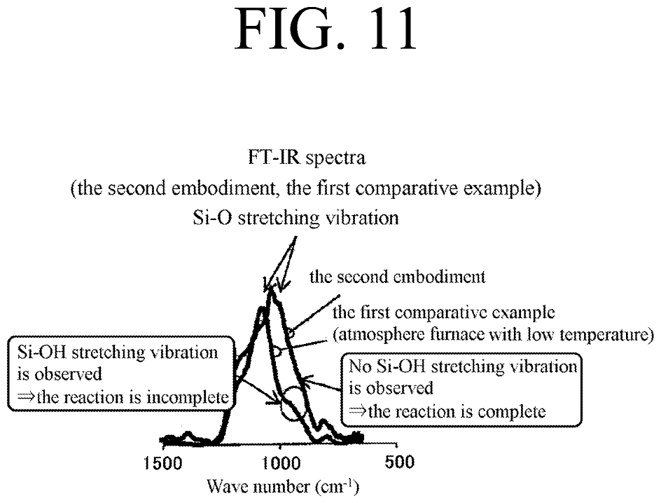

In addition, FIG. 10 illustrates FT-IR spectra of the inorganic compound obtained through baking in an atmosphere furnace (low temperature baking) according to the first comparative example and the inorganic compound obtained through baking in an atmosphere furnace (high temperature baking) according to the second comparative example. In addition, FIG. 11 illustrates FT-IR spectra of the inorganic compound obtained through baking by radiating ultraviolet light for short duration according to the second embodiment and the inorganic compound obtained through baking in the atmosphere furnace with low temperature according to the first comparative example.

In addition, a table 1 show results indicating whether or not reactions are completed on a basis of the FT-IR spectra with regard to the respective inorganic compounds according to the first embodiment, the second embodiment, the first comparative example, and the second comparative example.

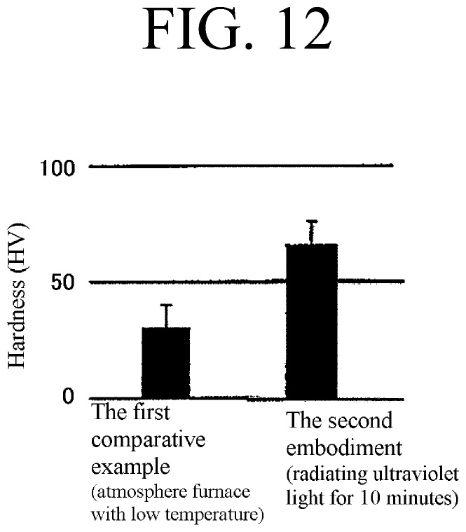

In addition, FIG. 12 illustrates a result of comparison between hardness of the inorganic compound obtained through baking by radiating ultraviolet light for a short duration according to the second embodiment and hardness of the inorganic compound obtained through baking in the atmosphere furnace with low temperature according to the first comparative example.

TABLE 1
Result of Evaluation of Reaction State

| Embodiment/ | | Si—O | Si—Oh | |
|---|---|---|---|---|
| Comparative | Baking | Stretching | Stretching | Completion of |
| Example | Method | Vibration | Vibration | Reaction |
| Embodiment 1 | Ultraviolet | Yes | No | Completed |
| | Light | | | (∘) |
| | Radiation | | | |
| Embodiment 2 | Ultraviolet | Yes | No | Completed |
| | Light | | | (∘) |
| | Radiation | | | |
| | (Short Time) | | | |
| Comparative | Atmosphere | Yes | Yes | Incomplete |
| Example 1 | Furnace (Low | | | (x) |
| | Temperature) | | | |
| Comparative | Atmosphere | Yes | No | Completed |
| Example 2 | Furnace (High | | | (∘) |
| | Temperature) | | | |

(4) Consideration

The formation of the inorganic compound (silicic acid compound) performed through the sol-gel process using the silicon alkoxide as the starting material is completed when hydroxyl groups in Si—OH formed through a hydrolysis reaction of the silicon alkoxide is subjected to dehydrating condensation caused by polycondensation reaction to form Si—O—Si bonds.

Therefore, if the inorganic compound includes an Si—O bond and Si—OH (the hydroxyl group) remains in the sample after baking, it is considered that the reaction is incomplete even when the silicic acid compound is formed.

The FT-IR spectrum has peak of Si—O stretching vibration when the wavelength is about 1000 cm⁻¹. All the inorganic compounds according to the first embodiment, the second embodiment, the first comparative example, and the second comparative example have spectrum shapes that peak near the wavelength of 1000 cm⁻¹, and it is confirmed that all the inorganic compounds obtained by any baking method form the Si—O bonds, that is, the silicic acid compounds are formed.

However, the Si—OH stretching vibration is observed in the spectrum shape of the inorganic compound baked in the atmosphere furnace with low temperature according to the first comparative example, and this means that Si—OH (the hydroxyl group) still remains, and the reaction is incomplete (see FIG. 11).

On the other hand, no Si—OH stretching vibration is observed in the spectrum shapes of the samples of the inorganic compounds baked by radiating ultraviolet light according to the first and second embodiments (see FIG. 8, FIG. 9, and FIG. 11), and this means that the number of remaining Si—OH (the hydroxyl groups) is less than or equal to a lower limit that can be detected through the FT-IR method, and it is confirmed that the reaction is substantially completed.

To complete the reaction during baking in the atmosphere furnace, it is necessary to perform baking for a relatively long duration at a high temperature that can change the dimension of the heat shield target as is the second comparative example.

On the other hand, in the case where baking is performed by radiating light having an wavelength in the ultraviolet band as is the present invention, such high-temperature baking is not necessary. In addition, even in the case where the baking is performed by radiating the ultraviolet light for a relatively short duration, it is possible to progress (complete) the polycondensation reaction to a state that is comparable to the second comparative example in which baking is performed for a relatively long duration at the high temperature that can change the dimension of the heat shield target.

Note that, as illustrated in FIG. 12, the hardness of the inorganic compound obtained through baking performed in the atmosphere furnace with low temperature according to the first comparative example is about 30 HV, but the hardness of the inorganic compound obtained through baking performed by radiating ultraviolet light for a short duration according to the second embodiment is about 65 HV, which is more than twice the number 30.

According to the above-described results, it is possible to complete the polycondensation reaction in the inorganic compound and form the inorganic compound having a higher hardness when the inorganic compound layer 10 is baked by radiating light having a wavelength of 500 nm or less, more preferably light having a wavelength in ultraviolet band (200 to 400 nm). In addition, the baking can be performed in a shorter time than the known baking method using the atmosphere furnace. Therefore, it is possible to prevent the heat shield target component from being affected by heat (such as change in dimension), and it is possible to form the inorganic compound having a higher hardness in a shorter time.

Test of Confirming Effect after pH adjustment

(1) Object of Test

An object of the test is to confirm whether pH adjustment of the alkoxide paint is efficacious in increasing the hardness of the inorganic compound after baking.

(3) Method of Test

The alkoxide paint (that includes mica as the scale-like inorganic particles) is prepared while the silicon alkoxide is used as the starting material. In addition, unadjusted paint (pH 9) and adjusted paint (pH 10) obtained by adding an amine into the paint as the pH adjuster are also prepared.

Note that, in this test example, m-xylylenediamine is used as the amine.

After respective coating films obtained through application of the unadjusted paint and the adjusted paint are subjected to preliminary baking and are hardened to a pencil hardness of 3H, the differential thermal analysis (TG-DTA) is performed to measure thermal change in the respective samples. In the differential thermal analysis (TG-DTA), thermogravimetric measurement (TG) and differential thermal analysis (DTA) are simultaneously performed. In the thermogravimetric measurement (TG), weight change in the respective samples are continuously measured while the samples are heated at a constant speed. In the differential thermal analysis (TG-DTA), change in a temperature difference between the samples is measured while the samples are heated together with a reference material.

In addition, baking in the atmosphere furnace with low temperature (same condition as the above-described first comparative example) and baking through radiation of ultraviolet light (same condition as the above-described second embodiment) are performed on samples that are similar to the samples used for the differential thermal analysis (TG-DTA), and hardness of inorganic compounds obtained through the baking is measured.

In addition, amounts of amines to be added are set to 0 mass %, 1 mass %, 2 mass %, 3 mass %, and 5 mass %, and adjusted raw material solutions having pH of 9, 9.5, 9.8, and 10 are used to obtain respective samples subjected to preliminary drying that is similar to the above-described method. Subsequently, hardness of inorganic compounds obtained by baking the respective samples through ultraviolet light radiation (in the same condition as the above-described second embodiment) is measured.

(3) Result of Test

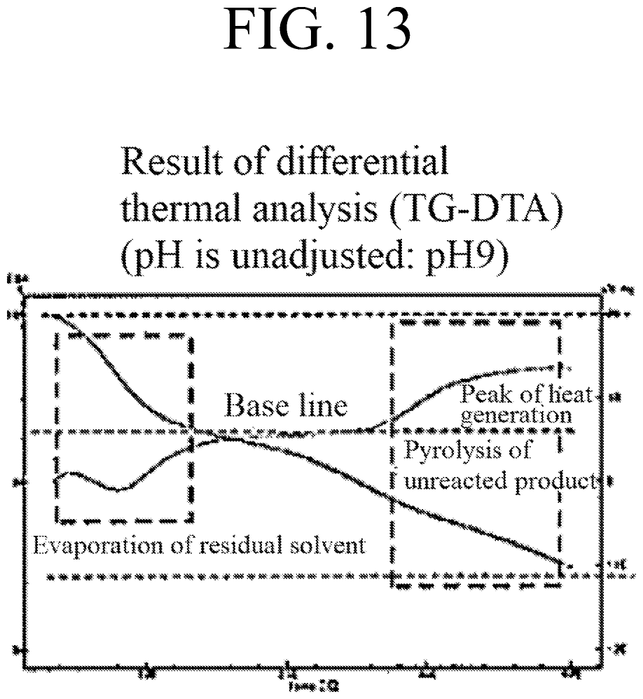

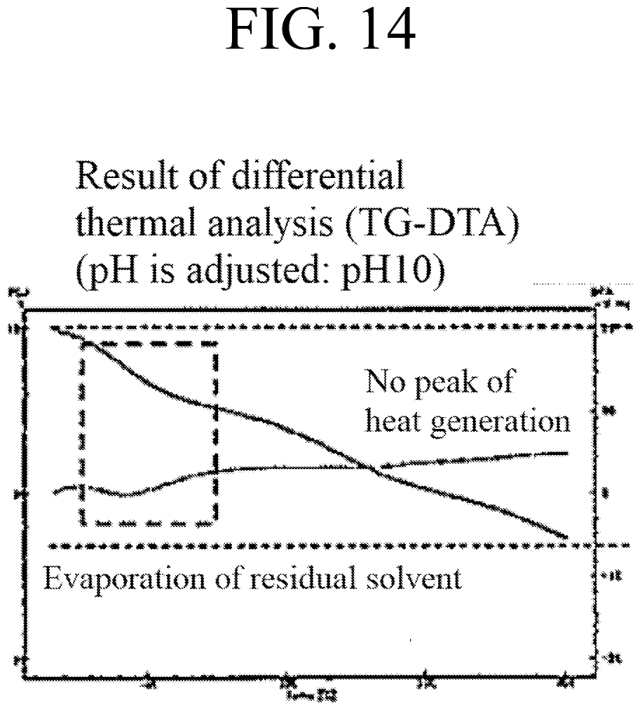

FIG. 13 illustrates a result of the TG-DTA performed on a sample obtained by using the unprocessed raw material solution (pH9) before pH adjustment. FIG. 14 illustrates a result of the TG-DTA performed on a sample obtained by using the processed raw material solution (pH10) after pH adjustment.

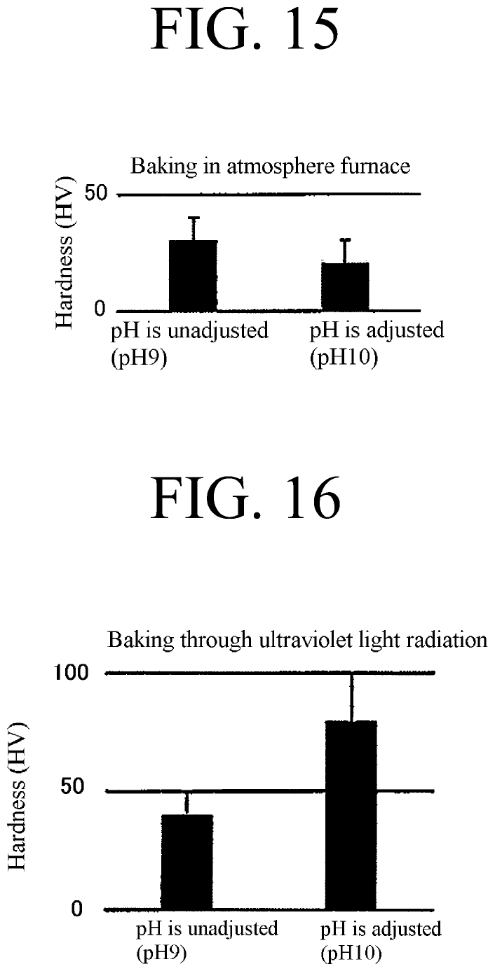

In addition, FIG. 15 illustrates change in hardness before/after pH adjustment in the case where baking is performed in the atmosphere furnace. FIG. 16 illustrates change in hardness before/after pH adjustment in the case where baking is performed by radiating ultraviolet light.

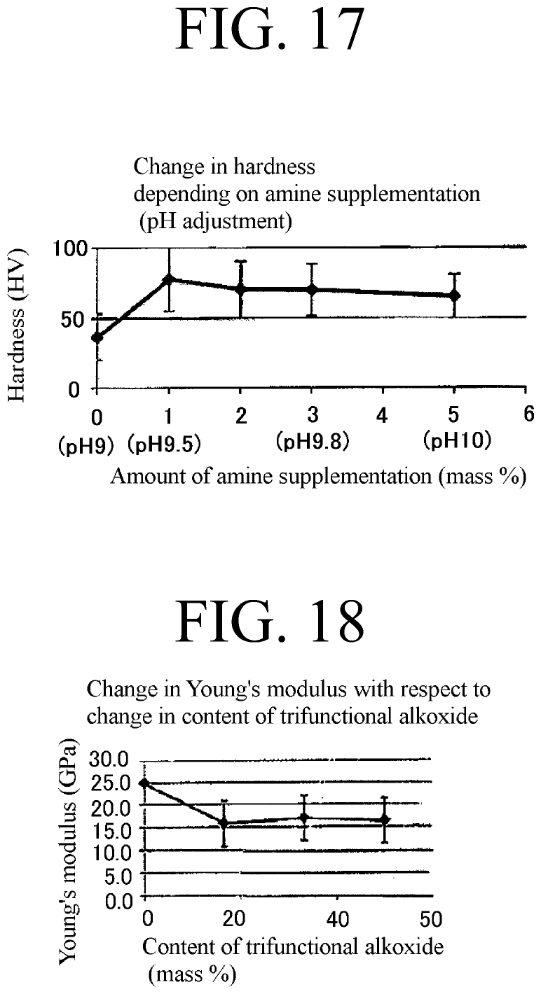

In addition, FIG. 17 illustrates change in hardness of an inorganic compound depending on amounts of amines to be added (change in pH).

(4) Consideration

(4-1) Relation with Hydrolysis Reaction

According to the result of differential thermal analysis (TG-DTA) illustrated in FIG. 13, a peak of heat generation is observed with regard to the sample formed using the unadjusted paint (pH 9). It is considered that the heat is generated when pyrolysis happens with regard to an unreacted silicon alkoxide remains without being subjected to hydrolysis. On the other hand, as illustrated in FIG. 14, no peak of heat generation is observed with regard to the sample formed using the adjusted paint (pH 10). In FIG. 14, a difference in temperature between the sample and the reference material substantially remains at a same level.

Accordingly, it can be considered that the hydrolysis of the raw material solution is accelerated by adjusting pH of the raw material solution from 9 to 10.

Note that, with reference to FIG. 4 illustrating the rate of hydrolysis reaction of alkoxide depending on change in pH, a lowest rate of hydrolysis reaction is observed when pH is 7 (neutral), and the rate increases as the pH changes toward the acidic direction or toward the alkaline direction.

Accordingly, it is possible to increase a rate of hydrolysis reaction of silicon alkoxide having an original pH of 9 when its pH is adjusted toward the alkaline direction in such a manner that the silicon alkoxide has pH of 9.5 or more than the pH of 9, for example. This makes it possible to shorten the preliminary baking duration and the final baking duration.

In addition, as illustrated in FIG. 4, the rate of hydrolysis reaction of alkoxide is improved not only in the case where the pH is adjusted toward the alkaline direction but also in the case where the pH is adjusted toward the acidic direction. Therefore, for example, it is possible to improve the rate of hydrolysis reaction of alkoxide when an acid such as phthalic anhydride is added as the pH adjuster to adjust the pH toward the acidic direction and obtain pH of 4 or less, for example. Therefore, it can be inferable that it is possible to shorten the preliminary baking duration and the final baking duration.

(4-2) Relation with Hardness of Inorganic Compound

In the case where the baking is performed in the atmosphere furnace as illustrated in FIG. 15, it is observed that the hardness is not increased but deteriorates even when pH of the paint is adjusted from 9 to 10.

On the other hand, in the example of performing baking through ultraviolet light radiation as illustrated in FIG. 16, it is observed that the hardness of the inorganic compound obtained after the baking drastically increases through pH adjustment.

Therefore, it is confirmed that a combination of pH adjustment of raw material solution and baking using ultraviolet light radiation is effective for increasing the hardness of the inorganic compound layer.

In addition, as illustrated in FIG. 17, the hardness increases by adding a tiny amount of amine (1 mass %). Therefore, it is confirmed that the hardness increases drastically only by adjusting pH a little bit toward the alkaline direction (adjusting pH to 9.5).

Test of Using Mixture of Tetrafunctional and Trifunctional Alkoxides

(1) Object of Test

An object of the test is to confirm whether the Young's modulus is decreased by adjusting the number of functional groups of the alkoxide. If the Young's modulus is decreased, this may result in prevention of cracks.

In addition, by adjusting both the amount of the pH adjuster and the number of functional groups, it is possible to find a condition that achieves conflicting demands including reduction in Young's modulus and maintenance of the effect obtained by increasing the hardness after pH adjustment.

(3) Method of Experiment

The Young's modulus of an inorganic compound layer is measured in the case where the inorganic compound layer is formed by using alkoxide paint (that includes mica as the scale-like inorganic particles) manufactured when using, as the starting material, alkoxides obtained by adding a trifunctional alkoxide into a tetrafunctional alkoxide and adjusting a trifunctional alkoxide content to 17 mass %, 33 mass %, and 50 mass %.

In addition, change in the hardness (HV) of the inorganic compound is also measured in the case where the inorganic compound is obtained when using, as the starting material, alkoxides in which amounts of trifunctional alkoxide to be added is adjusted to 0 mass %, 17 mass %, 33 mass %, and 55 mass %, and amounts of amine to be added as the pH adjuster vary among 0 to 5 mass %.

(3) Result of Test

FIG. 18 illustrates the change in Young's modulus depending on change in the amounts of trifunctional alkoxide to be added.

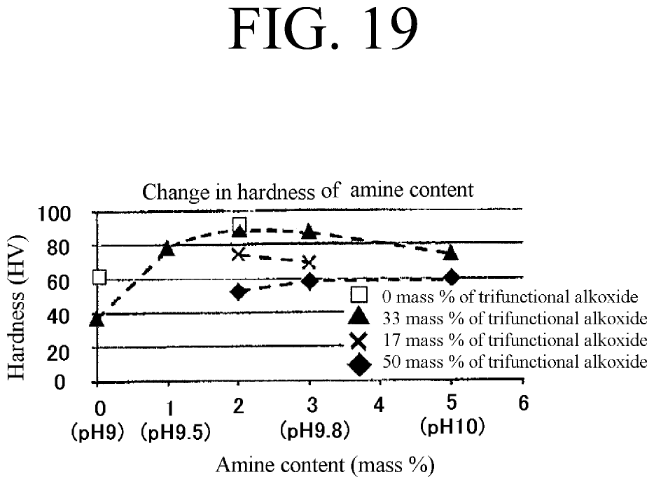

In addition, FIG. 19 illustrates change in hardness (HV) depending on change in amounts of amine to be added, with regard to respective inorganic compounds formed when using alkoxide paints using, as the starting material, alkoxides in which amounts of trifunctional alkoxide to be added is adjusted to 0 mass %, 17 mass %, 33 mass %, and 55 mass %.

Note that, a table 2 listed below illustrates examples of features obtained in the inorganic compound layers baked through ultraviolet light radiation and material composition that achieves the features (combination of amounts of amines to be added (pH adjustment) and amounts of trifunctional alkoxide to be added).

TABLE 2
Hardness and Young's Modulus of Inorganic Compound
Layer Baked Through Ultraviolet Light Radiation

| | Material Composition | | | Young's |
|---|---|---|---|---|
| | Amine | Trifunctional | Hardness | Modulus |
| Feature | (mass %) | (mass %) | (HV) | (GPa) |
| Maximum Hardness | 2 | 0 | 90 | 17 |
| Good Total Balance | 2 | 33 | 80 | 15 |
| Maximum Flexibility | 5 | 50 | 50 | 12 |
| Baking in Atmosphere | 0 | 0 | 40 | 25 |
| Furnace (For | | | | |
| Reference) | | | | |

(4) Consideration

As illustrated in FIG. 18, in the case of an inorganic compound formed using 100 mass % of tetrafunctional alkoxide (0 mass % of trifunctional alkoxide) as the starting material, the inorganic compound has the Young's modulus of about 25 GPa. However, it is observed that inorganic compounds to which trifunctional alkoxide are added has reduced Young's moduli that fall much below a goal value of 200 GPa.

Therefore, it is confirmed that addition of the trifunctional alkoxide is effective for reducing the Young's modulus, which is expected to prevent cracks.

In addition, with reference to FIG. 19 and the above-listed table 2, an inorganic component formed by adding 33 mass % of trifunctional alkoxide achieves the highest hardness among the inorganic components formed by adding trifunctional alkoxide. In particular, in the case of 2 mass % of amine to be added, the inorganic component formed by adding 33 mass % of trifunctional alkoxide has a peak hardness, and the peak hardness is slightly lower than but very close to the hardness of an inorganic component formed by adding 100 mass % of tetrafunctional alkoxide. The inorganic component formed by adding 33 mass % of trifunctional alkoxide has the Young's modulus that is drastically lower that the Young's modulus of the inorganic component formed by adding 100 mass % of tetrafunctional alkoxide while maintaining the high hardness of the inorganic component formed by adding 33 mass % of trifunctional alkoxide. Therefore, it is possible to satisfy conflicting demands, and achieve the unexpected effects.

[Fatigue Test and Endurance Test]

(1) Object of Experiment

An object of this experiment is to confirm endurance of the heat shield film according to the present invention in the case where the heat shield film including an inorganic compound layer is formed on the basis of the above-described test results and the heat shield film is formed on a top surface of a piston of an engine.

(2) Method of Test

(2-1) Target

### Embodiment

An alumite layer having a thickness of 40 μm is formed on a top surface of an aluminum alloy piston for an engine, and the alumite layer includes an oxide layer having a density of 2.5 g/cm³ through an anodizing process using a sulfuric acid bath.

An inorganic compound layer having a thickness of 25 μm is formed on the alumite layer, and the inorganic compound layer includes 40 mass % of mica as the scale-like inorganic particles. Accordingly, a heat shield film including the double layers that are the inorganic compound layer and the alumite layer is formed.

The inorganic compound layer is formed through the sol-gel process using tetrapropoxysilane as the starting material. Paint is formed by dispersing the scale-like inorganic particles including mica in a raw material solution obtained by mixing the tetrapropoxysilane and water via a solvent Next, the paint is applied to the alumite layer formed on the top surface of the piston to form a coating film. Subsequently, the piston on which the coating film is formed is subjected to preliminary baking and baking.

The baking is performed by radiating ultraviolet light (amount of heat of a light source is 2 to 4 kw and a peak illuminance is 700 to 1800 mW/cm²).

The paint to be used include a paint having a composition (2 mass % of amine and 0 mass % of trifunctional alkoxide) that achieves the highest hardness in the above-described test example, a paint having a composition (2 mass % of amine and 33 mass % of trifunctional alkoxide) that achieves a good total balance between the hardness and Young's modulus, and a paint having a composition (5 mass % of amine and 50 mass % of trifunctional alkoxide) that achieves highest flexibility.

### Comparative Example

As a comparative example, a paint (to which no amine or no alkoxide is added) that uses tetrafunctional alkoxide as the starting material and that is baked in the atmosphere furnace with low temperature is prepared instead baking performed through ultraviolet light radiation like the above-described embodiment.

(2-2) Unit Fatigue Testing (Hydropulse Test)

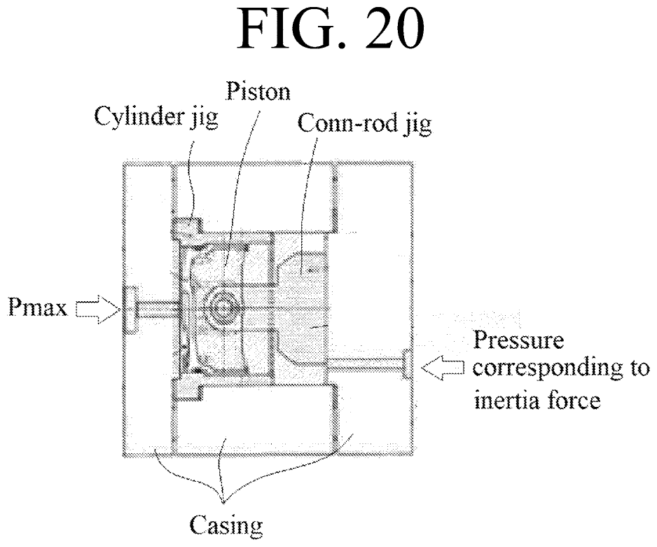

Unit fatigue testing is performed on pistons according to the embodiments and the comparative examples by using hydropulse test equipment illustrated in FIG. 20.

In the test, a piston provided with a conn-rod jig is stored in a casing in a state where the piston is stored in a cylinder jig, and a pressure corresponding to a maximum combustion pressure (Pmax) is periodically applied to silicone oil that is filled in a portion corresponding to a combustion chamber while a pressure corresponding to inertia force of the piston is applied from the conn-rod jig side.

The test condition may include a condition that pressure of 8 MPs corresponding to the maximum combustion pressure (Pmax) is applied at a 30 Hz frequency. The test temperature is 250° C. and a repetition rate is 1×10⁷.

(2-3) Endurance Test (Actual Engine Test)

The endurance test is performed while the piston according to the embodiment and the piston according to the comparative example are mounted on respective engines.

The engine to be used is a mass-produced natural aspiration engine having straight four cylinders with displacement of 2.5 liters, and full load operation of 6000 min⁻¹ is performed for 60 hours. The maximum combustion pressure in the combustion chamber is 7 MPa.

(3) Result of Test and Consideration

(3-1) Result of Unit Fatigue Testing (Hydropulse Test)

As a result of the unit fatigue testing (hydropulse test), the inorganic compound layer cracks in parallel to a painting surface and intralayer separation is caused in the inorganic compound layer due to extension in the case of using the piston according to the comparative example.

In addition, in the case of the piston according to the comparative example, breakage is also observed near an interface between the alumite layer and the inorganic compound layer.

It can be inferable that such breakage near the interface between the alumite layer and the inorganic compound layer is caused by “pores” in the alumite layer. The pores are fine holes and includes gas that may expand due to test environmental temperature, and this may result in breakage in the deteriorated inorganic compound layer above the pores.

On the other hand, in the case of the piston according to the present embodiment on which the heat shield film is formed through the method using any paint composition according to the present invention, the breakage and separation in the inorganic compound layer are reduced to more than 50% of the breakage and separation occurred in the comparative example.

In addition, there is no evidence of big breakage at the interface between the alumite layer and the inorganic compound layer.

This is because the inorganic compound layer formed by using the method according to the present invention has an enhanced hardness in comparison with the comparative example, and this makes it possible to suppress breakage on the interface between the alumite layer and the inorganic compound layer, the breakage being caused by expansion of gas in the pores.

As described above, it is confirmed that the heat shield film formed on the piston according to the embodiment has a fatigue strength that is drastically improved in comparison with a heat shield film formed on the piston according to the comparative example. In addition, it is confirmed that the ultraviolet light radiation is effective for baking the inorganic compound layer.

(3-2) Result of Endurance Test (Actual Engine Test)

As a result of the endurance test performed while the piston according to the embodiment and the piston according to the comparative example are mounted on respective engines, the separation occurs in the inorganic compound layer of the piston according to the comparative example, the cracks occurs and extends in the layer, and the breakage and defect occurs in the layer due to the extended cracks connected to each other.

As a result, after the test, the film thickness of the heat shield film formed on the piston according to the comparative example is reduced to 20 to 30% of the film thickness (10%) obtained before the test.

On the other hand, in the case of the piston according to the present embodiment on which the heat shield film is formed through the method using any paint composition according to the present invention, it is confirmed that a crack occurrence rate in the inorganic compound layer is reduced to 50% to 70% of a crack occurrence rate according to the comparative example.

In addition, in the case of using the piston according to the embodiment, the film thickness of the heat shield film does not change before/after the test, and the film thickness obtained before the test is maintained even after the test.

This is because the inorganic compound layer formed through the method according to the present invention has an improved hardness.

In other words, even if the cracks occurs in the inorganic compound layer of the piston according to the embodiment, since the inorganic compound layer has the improved hardness, it can be inferable that the piston according to the embodiment can suppress the cracks that extend in the layer and suppress connection of the extended cracks to each other, and it is possible to prevent the breakage and defect from occurring in the layer.

Accordingly, the effectiveness of the present invention that bakes the inorganic compound layer through ultraviolet light radiation is confirmed by the result of the endurance test (actual engine test).

### EXPLANATION OF REFERENCE NUMERALS

1. Heat shield film
2. Heat shield target component (piston)
10. Inorganic compound layer
11. Inorganic compound
12. Scale-like inorganic particles
20. Alumite layer.

1. A vehicle heat shield component comprising:
a heat shield film that covers at least a portion of a surface of a heat shield target component,
the heat shield film including at least an inorganic compound layer having one or more kinds of scale-like inorganic particles dispersed in an inorganic compound that includes alkoxide, the one or more kinds of scale-like inorganic particles being selected from a group consisting of mica, talk, and wollastonite, and
the inorganic compound layer having a Vickers hardness of 50 to 100 HV.

2. The vehicle heat shield component according to claim 1,
wherein the inorganic compound layer has a Young's modulus of 12 to 25 GPa.

3. The vehicle heat shield component according to claim 1,
wherein the heat shield film includes an alumite layer below the inorganic compound layer.

4. The vehicle heat shield component according to claim 3,
wherein the alumite layer is a sulfuric-acid alumite layer.

5. The vehicle heat shield component according to claim 1,
wherein the inorganic compound layer has a thickness of 10 to 200 μm.

6. The vehicle heat shield component according to claim 1,
wherein the heat shield film has a thickness of 10 to 400 μm.

7. The vehicle heat shield component according to claim 1,
wherein the heat shield target component has an external dimension having been maintained since before the heat shield film is formed.

8. The vehicle heat shield component according to claim 1,
wherein the alkoxide is a mixture of 30 to 100 mass % of tetrafunctional alkoxide and 0 to 70 mass % of bifunctional or trifunctional alkoxide.

9. The vehicle heat shield component according to claim 1,
wherein the heat shield target component is a piston for an engine.

10. A heat shield film formed on a portion of at least a surface of a heat shield target component, the heat shield film constituting a vehicle heat shield component with the heat shield target component, the heat shield film comprising:
at least an inorganic compound layer having one or more kinds of scale-like inorganic particles dispersed in an inorganic compound that includes alkoxide, the one or more kinds of scale-like inorganic particles being selected from a group consisting of mica, talk, and wollastonite, the inorganic compound layer having a Vickers hardness of 50 to 100 HV.

11. The heat shield film according to claim 10, comprising an alumite layer below the inorganic compound layer.

12. The heat shield film according to claim 11,
wherein the alumite layer has a thickness of 10 to 200 μm.

13. The heat shield film according to claim 10,
wherein the inorganic compound layer has a thickness of 10 to 200 μm.

14. The heat shield film according to claim 10,
wherein the heat shield film is formed on a surface of the heat shield target component having an external dimension that has been maintained since before the heat shield film is formed.

15. A method of manufacturing a vehicle heat shield component including a heat shield film that covers at least a portion of a surface of a heat shield target component,
the heat shield film including at least an inorganic compound layer having one or more kinds of scale-like inorganic particles dispersed therein, the one or more kinds of scale-like inorganic particles being selected from a group consisting of mica, talk, and wollastonite,
the method comprising:
a paint manufacturing step of manufacturing paint including an alkoxide solution including scale-like inorganic particles dispersed therein;
a coating film forming step of forming a coating film by applying the paint to the surface of the heat shield target component; and
a baking step of baking the coating film by irradiation of a light having a wavelength of 500 nm or less.

16. The method of manufacturing a vehicle heat shield component according to claim 15,
wherein the alkoxide is a mixture of 30 to 100 mass % of tetrafunctional alkoxide and 0 to 70 mass % of bifunctional and/or trifunctional alkoxide.

17. The method of manufacturing a vehicle heat shield component according to claim 15, wherein
the heat shield film includes an alumite layer, and
the coating film forming step is performed on the surface of the heat shield target component that includes aluminum or an aluminum alloy and on which the alumite layer is formed.

18. The method of manufacturing a vehicle heat shield component according to claim 17,
wherein the alumite layer is formed through an anodizing process using a sulfuric acid bath.

19. The method of manufacturing a vehicle heat shield component according to claim 15,
wherein the heat shield target component is a piston for an engine.
